(19) United States
(12) Patent Application Publication
(10) Pub. No.: US 2012/0190222 A1
(43) Pub. Date: Jul. 26, 2012

(54) PROTECTION APPARATUS FOR MEMORY SOCKETS

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/095,916

(22) Filed: Apr. 28, 2011

(30) Foreign Application Priority Data
Jan. 25, 2011 (CN) 201110026822.3

(51) Int. Cl. H01R 13/44

(52) U.S. Cl. 439/135

(57) ABSTRACT

A protection apparatus is provided to protect at least one socket. The protection apparatus includes a main body, and at least one plugging board substantially perpendicularly extending from a bottom of the main body to be plugged into the at least one socket.

### BACKGROUND

1. Technical Field

The disclosure relates to a protection apparatus for memory sockets.

2. Description of Related Art

In a computer, a plurality of memory sockets is often mounted on a motherboard of a computer, to mount memories, thereby expanding function of the computer. However, idle sockets may be damaged if bumped or from accumulating dust.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of a first exemplary embodiment of a protection apparatus and a motherboard.

FIG. 2 is an enlarged, inverted, isometric view of the protection apparatus of FIG. 1.

FIG. 3 is an assembled, isometric view of FIG. 1.

FIG. 4 is an isometric view of a second exemplary embodiment of a protection apparatus.

FIG. 5 shows a state of use of the protection apparatus of FIG. 4.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

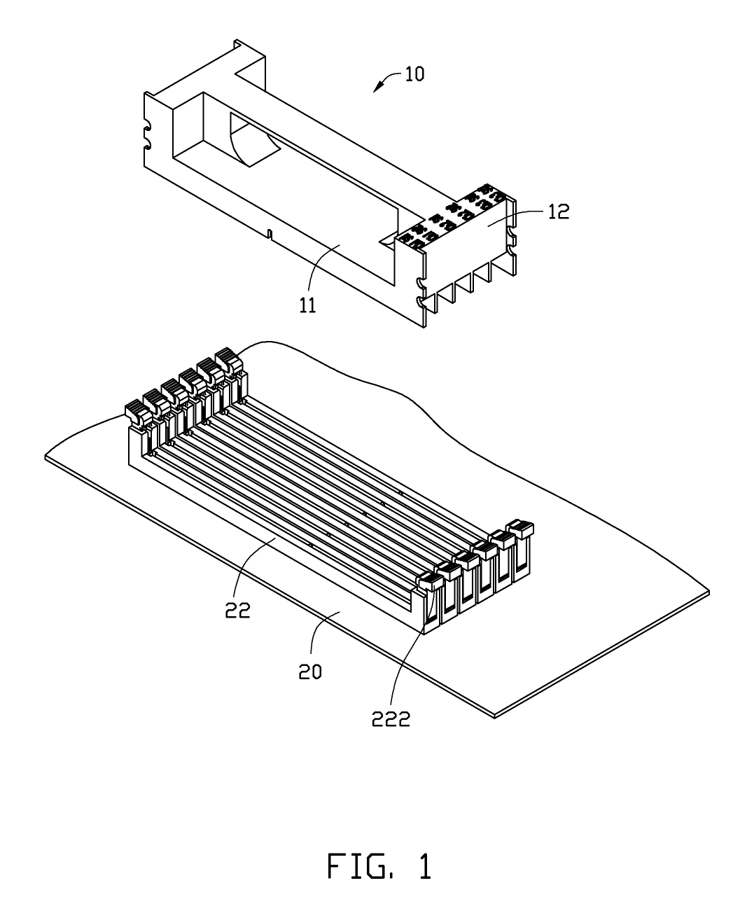

Referring to FIG. 1, a first exemplary embodiment of a protection apparatus 10 is set on a motherboard 20 to protect a plurality of memory sockets 22 arranged on the motherboard 20. Two latches 222 are pivotably mounted to opposite ends of each memory socket 22.

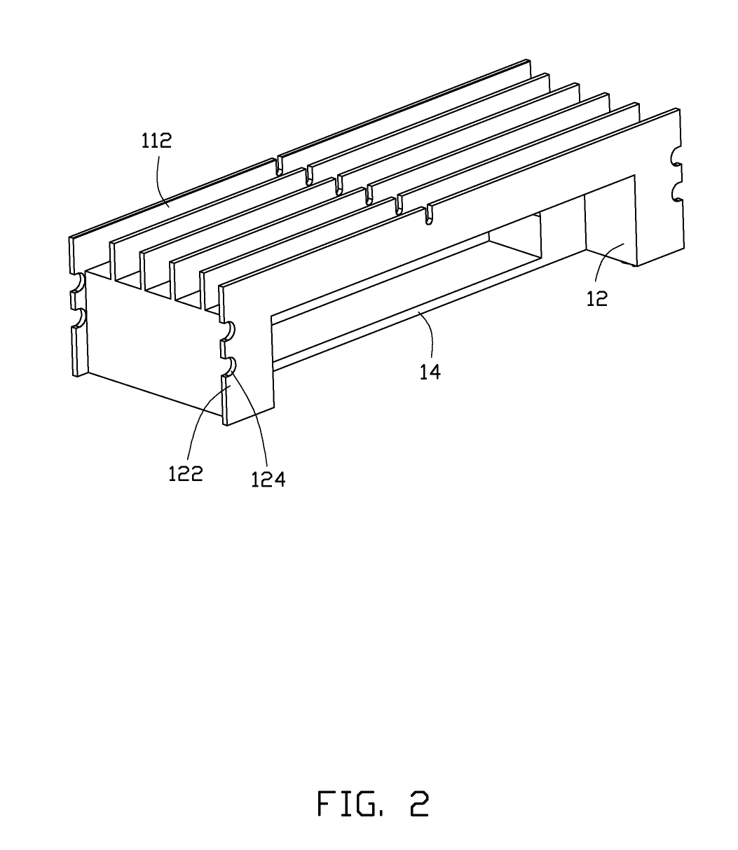

Referring to FIG. 2, the protection apparatus 10 includes a main body 11, two locking portions 12 substantially perpendicularly extending up from opposite ends of the main body 11, and a handle 14 connected between tops of the locking portions 12. A plurality of spaced plugging boards 112 perpendicularly extends from a bottom of the main body 11, corresponding to the memory sockets 22. Two engaging plates 122 substantially perpendicularly extend from two opposite sides of each locking portion 12. Each engaging plate 122 defines a plurality of latching cutouts 124. The handle 14 defines a plurality of skidproof strips (not shown), to facilitate grasping and operating the handle 14.

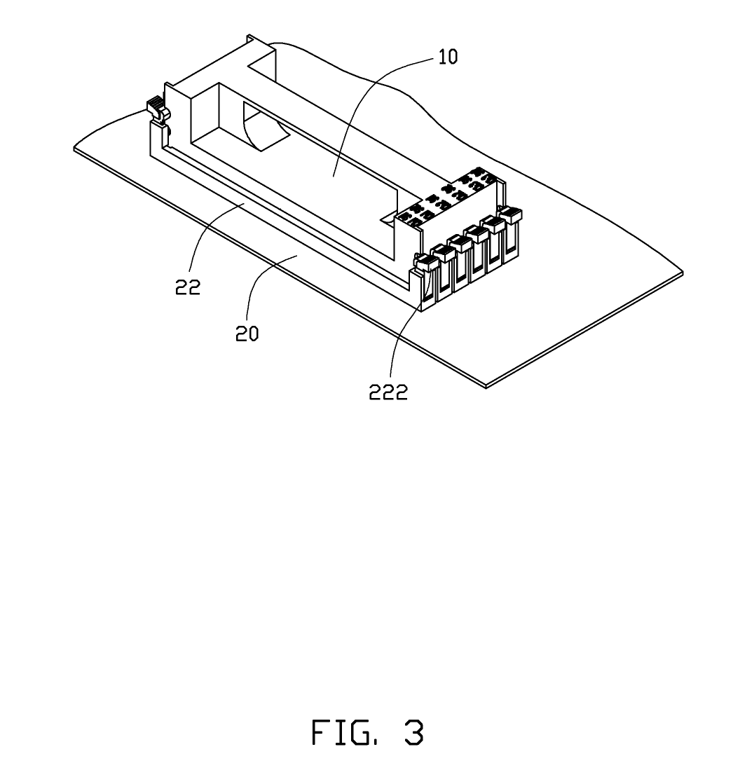

Referring to FIG. 3, in assembly, the plugging boards 112 are plugged into the memory sockets 22. The latches 222 of the corresponding memory sockets 22 are latched in the corresponding latching cutouts 124 of the protection apparatus 10. Thereby, the protection apparatus 10 is mounted to the memory sockets 22 to protect the memory sockets 22 from being damaged and accumulating dust.

When the memory sockets 22 need to be used, the engaging plates 122 are operated to separate the latches 222 from the latching cutouts 124. The handle 14 is drawn to separate the protection apparatus 10 from the memory sockets 22.

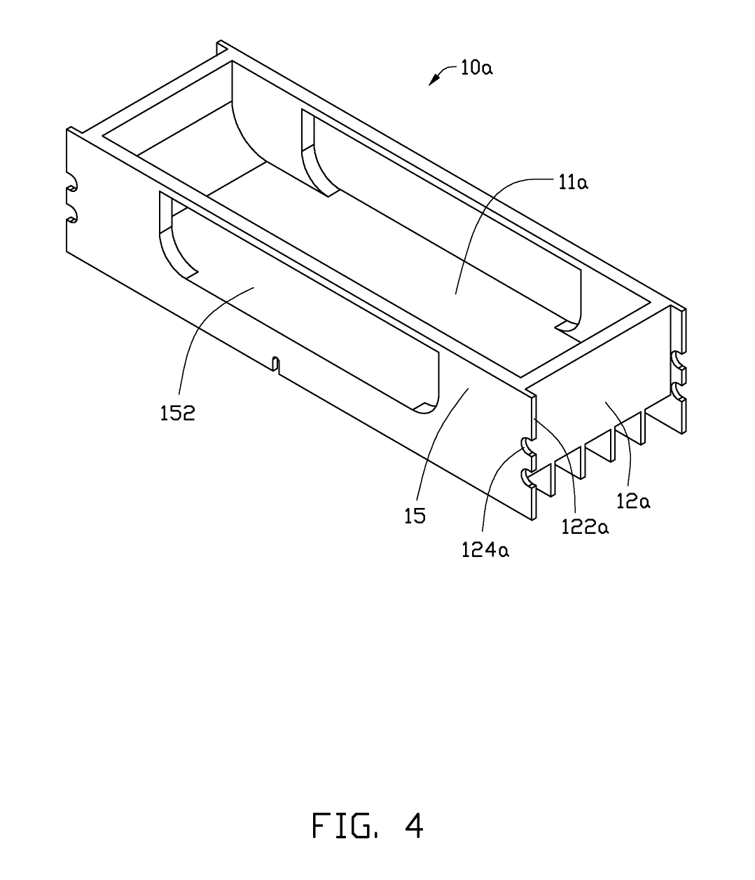

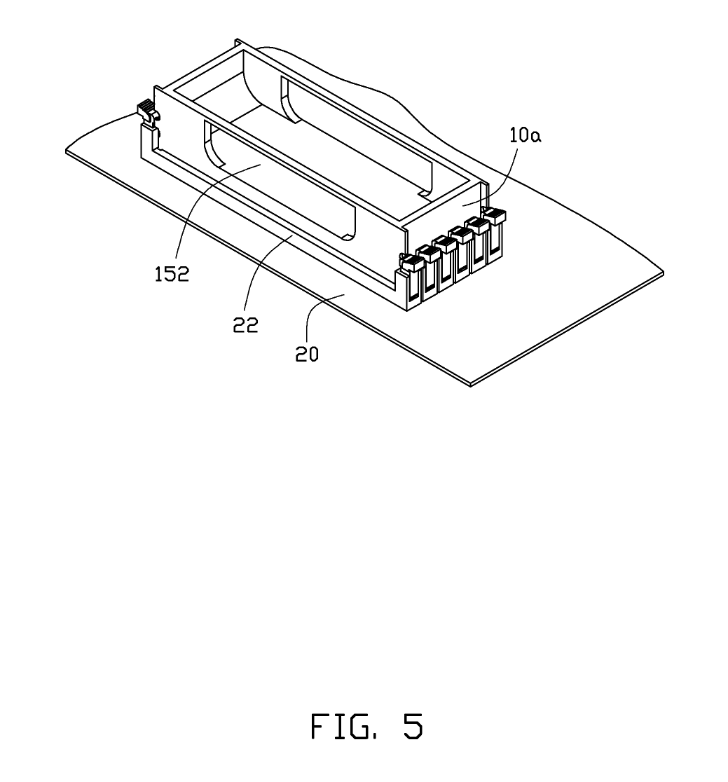

Referring to FIGS. 4 and 5, a second exemplary embodiment of a protection apparatus 10a is similar to the first exemplary embodiment of the protection apparatus 10, except that two lateral plates 15 perpendicularly extend from two opposite sides of the main body 11a to replace the handle 14 to be connected between locking portions 12a of the protection apparatus 10. The lateral plates 15 each define an opening 152 aligning with each other for allowing manual removal of the protection apparatus 10a.

It is believed that the present embodiment and its advantages will be understood from the foregoing description, and it will be apparent that various changes may be made thereto without departing from the spirit and scope of the description or sacrificing all of their material advantages, the example hereinbefore described merely being exemplary embodiment.

What is claimed is:

1. A protection apparatus to protect at least one socket, the protection apparatus comprising:
a main body; and
at least one plugging board substantially perpendicularly extending from a bottom of the main body to be plugged into the at least one socket.

2. The protection apparatus of claim 1, wherein two locking portions substantially perpendicularly extend up from opposite ends of the main body, each locking portion defines a latching cutout for latching the at least one socket.

3. The protection apparatus of claim 2, further comprising a handle, wherein the handle is connected between the locking portions.

4. The protection apparatus of claim 2, wherein two engaging plates extend from opposite ends of each locking portion, the latching cutouts are defined in the engaging plates for engaging with the at least one socket.

5. The protection apparatus of claim 2, wherein two lateral plates substantially perpendicularly extend up from opposite sides of the main body and are connected between the latching portions, the lateral plates each define an opening.
